(19) United States
(12) Patent Application Publication
(10) Pub. No.: US 2020/0034502 A1
(43) Pub. Date: Jan. 30, 2020

(54) ARCHITECTURE SELECTION DEVICE, ARCHITECTURE SELECTION METHOD, AND COMPUTER READABLE MEDIUM

(71) Applicant: MITSUBISHI ELECTRIC CORPORATION, Tokyo (JP)

(72) Inventors: Yoshihiro OGAWA, Tokyo (JP); Tomomi TAKEUCHI, Tokyo (JP); Koki MURANO, Tokyo (JP)

(73) Assignee: MITSUBISHI ELECTRIC CORPORATION, Tokyo (JP)

(21) Appl. No.: 16/477,288

(22) PCT Filed: Mar. 7, 2017
(86) PCT No.: PCT/JP2017/009039

§ 371 Date: Jul. 11, 2019

(51) Int. Cl. G06F 17/50

(52) U.S. Cl. CPC G06F 17/5009

(57) ABSTRACT

In an architecture selection device, an evaluation unit evaluates performance of each of candidates for a combination of processing components to be integrated into a system to be designed. An aggregation unit aggregates costs of each of candidates for a combination of hardware components to be integrated into the system to be designed. A first selection unit and a second selection unit select one combination of the hardware components, as architecture of the system to be designed, from among the candidates for the combination of the hardware components to be integrated into the system to be designed. The combination of the hardware components that is to be selected is a combination of the hardware components which includes a combination of the processing components having the performance evaluated by the evaluation unit satisfying a constraint condition on the performance and whose costs aggregated by the aggregation unit satisfy a constraint condition on the costs.

### TECHNICAL FIELD

The present invention relates to an architecture selection device, an architecture selection method, and an architecture selection program.

### BACKGROUND ART

In design of an embedded system, requirements analysis is conducted in accordance with system requirements. Division of operating specifications of the entire system into functional blocks and operating specification design for each functional block are carried out. After hardware components for implementation of the functional blocks are selected, each of the functional blocks is partitioned into software and hardware. Implementation of the software and the hardware is thereafter carried out. In the design of embedded systems, final results of the implementation need to satisfy constraint conditions on performance and costs. Therefore, selection of the components and partition of the functional blocks into the software and the hardware that are carried out at stages prior to the design are important. Knowledge on the components and knowledge on and experience of the implementation of the software and the hardware are required therein.

Patent Literature 1 discloses a technique at supporting system design.

In the technique disclosed in Patent Literature 1, functional design is prepared with use of a function library and a test bench library. IP functional design is prepared with use of an IP function library. The term “IP” is an abbreviation for Intellectual Property. In the functional design and the IP functional design, functions required for IP are described in C language.

Subsequent to the functional design and the IP functional design, system architecture design is prepared with use of an architecture model library. In the system architecture design, necessary HW and SW models are selected from the architecture model library. The term “HW” is an abbreviation for Hardware. The term “SW” is an abbreviation for Software. The models are connected to buses to construct a schematic structure of the entire system.

Subsequent to the system architecture design, mapping for allocation of the functional blocks to respective components of the architecture is carried out. After that, performance analysis is conducted with use of a performance library. In case where performance is not satisfied as a result, the mapping and the performance analysis are conducted afresh. Loop processing in which the mapping and the performance analysis are iterated is executed until the performance is satisfied.

Subsequent to the mapping and the performance analysis, HW design with use of an IP hardware model library and SW design with use of an IP software model library are separately prepared. When the HW and SW are refined, HW/SW co-verification with use of an interface model is conducted. After that, real chips are used for confirmation of functions of the real chips.

### CITATION LIST

### Patent Literature

Patent Literature 1: JP 2002-157291

### SUMMARY OF INVENTION

### Technical Problem

In the technique disclosed in Patent Literature 1, the system architecture design has to be prepared afresh in case where the performance is not satisfied through the mapping. In addition, the system architecture design needs to be prepared by a system designer. The system designer needs to re-prepare a design that satisfies the constraint conditions on the performance and the costs, based on the result of the performance analysis.

The present invention aims at selecting a combination of components that satisfies the constraint conditions on the performance and the costs, as architecture of a system, without depending on a system designer.

### Solution to Problem

An architecture selection device according to an aspect of the present invention includes:

an evaluation unit to evaluate performance of each of candidates for a combination of processing components that are hardware components to execute processes among hardware components to be integrated into a system to be designed;

an aggregation unit to acquire component information defining costs of the individual hardware components from a memory and to aggregate costs of each of candidates for a combination of the hardware components to be integrated into the system, based on the acquired component information; and

a selection unit to select a candidate for the combination of the hardware components which includes a combination of the processing components having the performance evaluated by the evaluation unit satisfying a constraint condition on the performance given to the system and whose costs aggregated by the aggregation unit satisfy a constraint condition on the costs given to the system, as architecture of the system, from among the candidates for the combination of the hardware components to be integrated into the system.

### Advantageous Effects of Invention

According to the present invention, it is made possible to select the combination of the components that satisfies the constraint conditions on the performance and the costs, as the architecture of the system, without depending on a system designer.

### BRIEF DESCRIPTION OF DRAWINGS

FIG. 1 is a block diagram illustrating a configuration of a design support system according to Embodiment 1.

FIG. 2 is a flowchart illustrating operation of an architecture selection device according to Embodiment 1.

FIG. 3 is a diagram illustrating an example of a source code of a functional model according to Embodiment 1.

FIG. 4 is a diagram illustrating examples of an analysis result and a measurement result of number of arithmetic operations and amounts of data in the functional model according to Embodiment 1.

FIG. 5 is a diagram illustrating examples of an analysis result and a measurement result of the number of arithmetic operations and the amounts of data in the functional model according to Embodiment 1.

FIG. 6 is a diagram illustrating an example of computing resource data according to Embodiment 1.

FIG. 7 is a diagram illustrating an example of computing resource data according to Embodiment 1.

FIG. 8 is a diagram illustrating an example of computing resource data according to Embodiment 1.

FIG. 9 is a diagram illustrating an example of computing resource data according to Embodiment 1.

FIG. 10 is a diagram illustrating examples of evaluation results on computing resources according to Embodiment 1.

FIG. 11 is a diagram illustrating examples of evaluation results on computing resources according to Embodiment 1.

FIG. 12 is a diagram illustrating examples of evaluation results on the computing resources according to Embodiment 1, constraint conditions and priority levels, and calculation results of MIPS.

FIG. 13 is a diagram illustrating of an example of architecture information according to Embodiment 1.

FIG. 14 is a diagram illustrating an example of component information according to Embodiment 1.

FIG. 15 is a diagram illustrating an example of component information according to Embodiment 1.

FIG. 16 is a diagram illustrating an example of a selection result for components according to Embodiment 1.

FIG. 17 is a diagram illustrating an example of a selection result for components according to Embodiment 1.

### DESCRIPTION OF EMBODIMENTS

Hereinbelow, an embodiment of the present invention will be described with use of the drawings. In the drawings, identical parts or corresponding parts are provided with identical reference characters. In description of the embodiment, description of the identical parts or the corresponding parts will be omitted or simplified appropriately. Note that the present invention is not to be limited by the embodiment to be described below but may be modified in various manners as appropriate. For instance, the embodiment to be described below may be partially embodied.

### Embodiment 1

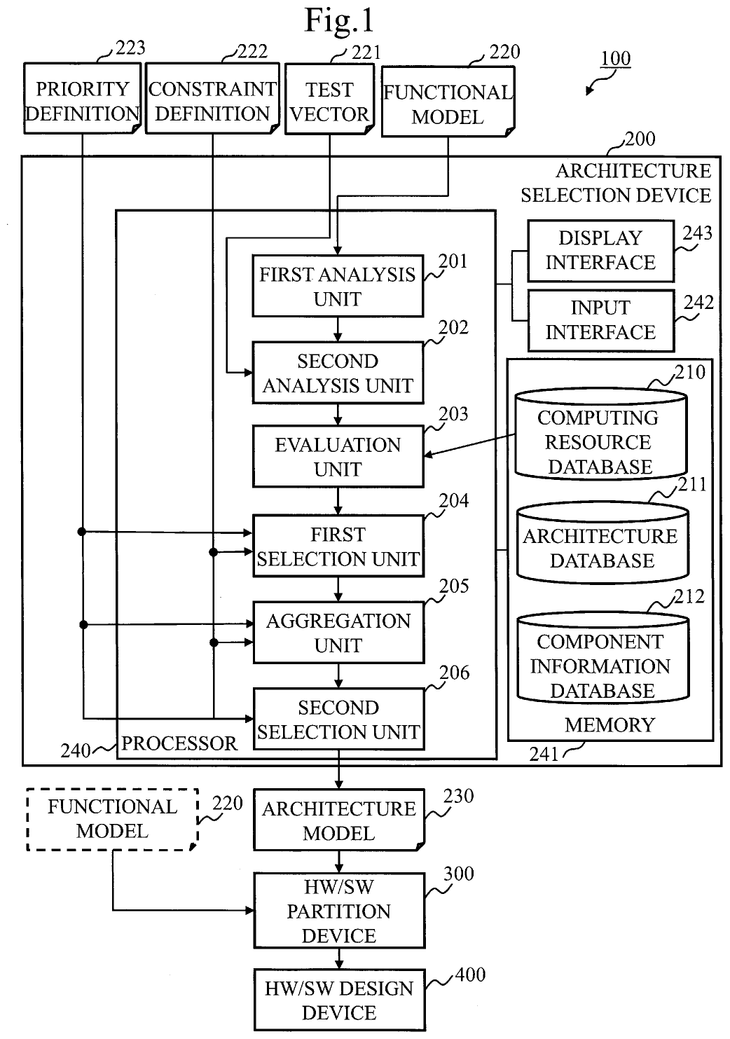

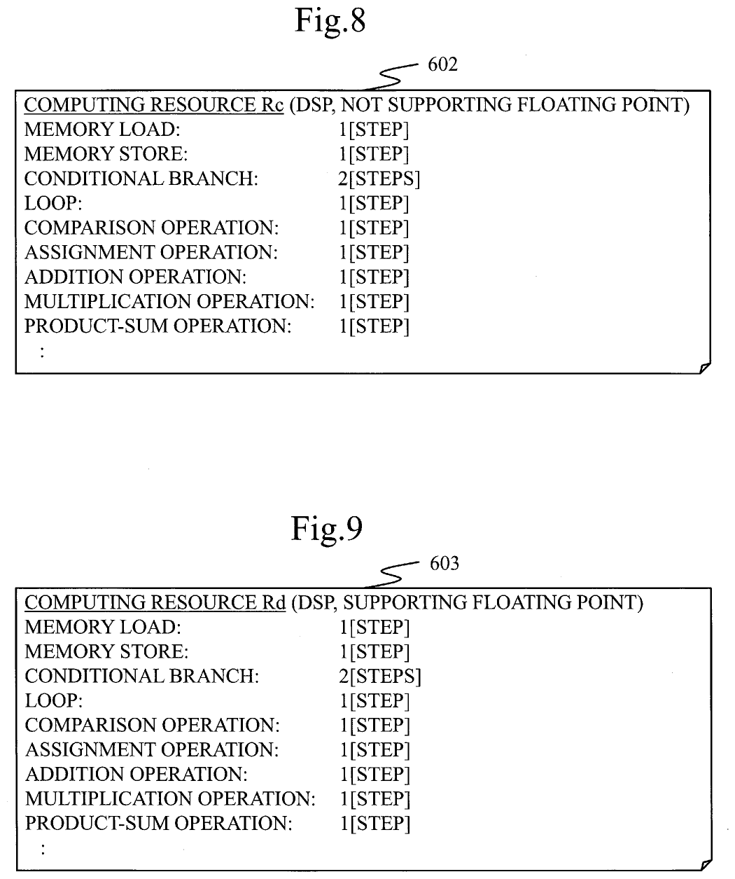

The present embodiment will be described with use of FIGS. 1 to 17.

***Description of Configuration***

With reference to FIG. 1, a configuration of a design support system 100 according to the embodiment will be described.

The design support system 100 is a system to support design of an embedded system or another system based on a specification description. The design support system 100 includes an architecture selection device 200, an HW/SW partition device 300, and an HW/SW design device 400.

The architecture selection device 200 receives a functional model 220, a test vector 221, a constraint definition 222, and a priority definition 223, as input, and outputs an architecture model 230. The architecture model 230 outputted by the architecture selection device 200 and the functional model 220 are inputted into the HW/SW partition device 300. The HW/SW partition device 300 carries out HW/SW partition equivalent to the prior art technique. The HW/SW design device 400 receives a result of the HW/SW partition by the HW/SW partition device 300 and accordingly prepares HW design and SW design that are equivalent to the prior art technique. The HW/SW partition may be carried out by a system designer, instead of the HW/SW partition device 300. The HW design and the SW design may be prepared by the system designer, instead of the HW/SW design device 400.

The functional model 220 is data in which functional specifications of a system to be designed, such as an embedded system, are described in C language or the like. The test vector 221 represents setting values, input data, and the like for simulation of the functional model 220. The constraint definition 222 represents data in which constraints on performance, costs, and the like of the system to be designed are described. The priority definition 223 represents data in which priority levels, weights, and the like of the constraint definition 222 are described.

The architecture selection device 200 is a computer. The architecture selection device 200 includes a processor 240 and other hardware such as a memory 241, an input interface 242, and a display interface 243. The processor 240 is connected to the other hardware through signal lines so as to control the other hardware.

The architecture selection device 200 includes a first analysis unit 201, a second analysis unit 202, an evaluation unit 203, a first selection unit 204, an aggregation unit 205, and a second selection unit 206, as functional components. Functions of the first analysis unit 201, the second analysis unit 202, the evaluation unit 203, the first selection unit 204, the aggregation unit 205, and the second selection unit 206 are implemented by software.

The processor 240 is an IC to execute various processes. The term “IC” is an abbreviation for Integrated Circuit. The processor 240 is a CPU, for instance. The term “CPU” is an abbreviation for Central Processing Unit.

A computing resource database 210, an architecture database 211, and a component information database 212 are built up in the memory 241. The memory 241 is a flash memory or a RAM, for instance. The term “RAM” is an abbreviation for Random Access Memory.

The input interface 242 is a port to be connected to an input device not illustrated. The input interface 242 is a USB terminal, for instance. The term “USB” is an abbreviation for Universal Serial Bus. The input device is a mouse, a keyboard, or a touch panel, for instance.

The display interface 243 is a port to be connected to a display not illustrated. The display interface 243 is a USB terminal, for instance. The display is an LCD, for instance. The term “LCD” is an abbreviation for Liquid Crystal Display.

The architecture selection device 200 may include a communication device as hardware.

The communication device includes a receiver to receive data and a transmitter to transmit data. The communication device is a communication chip or an NIC, for instance. The term “NIC” is an abbreviation for Network Interface Card.

In the memory 241, an architecture selection program that is a program to implement the functions of the first analysis unit 201, the second analysis unit 202, the evaluation unit 203, the first selection unit 204, the aggregation unit 205, and the second selection unit 206 is stored. The architecture selection program is read into the processor 240 and is executed by the processor 240. An OS is also stored in the memory 241. The term “OS” is an abbreviation for Operating System. The processor 240 executes the architecture selection program while executing the OS. A portion or entirety of the architecture selection program may be integrated into the OS.

The architecture selection program and the OS may be stored in an auxiliary storage device. The auxiliary storage device is a flash memory or an HDD, for instance. The term “HDD” is an abbreviation for Hard Disk Drive. The architecture selection program and the OS that are stored in the auxiliary storage device are loaded into the memory 241 and are executed by the processor 240.

The architecture selection device 200 may include a plurality of processors to substitute for the processor 240. Execution of the architecture selection program is divided among the plurality of processors. Each of the processors is an IC to execute various processes as with the processor 240.

Information, data, signal values, and variable values that indicate results of processes in the first analysis unit 201, the second analysis unit 202, the evaluation unit 203, the first selection unit 204, the aggregation unit 205, and the second selection unit 206 are stored in the memory 241, the auxiliary storage device, or a register or a cache memory in the processor 240.

The architecture selection program may be stored in a portable storage medium such as a magnetic disc and an optical disc.

***Description of Operation***

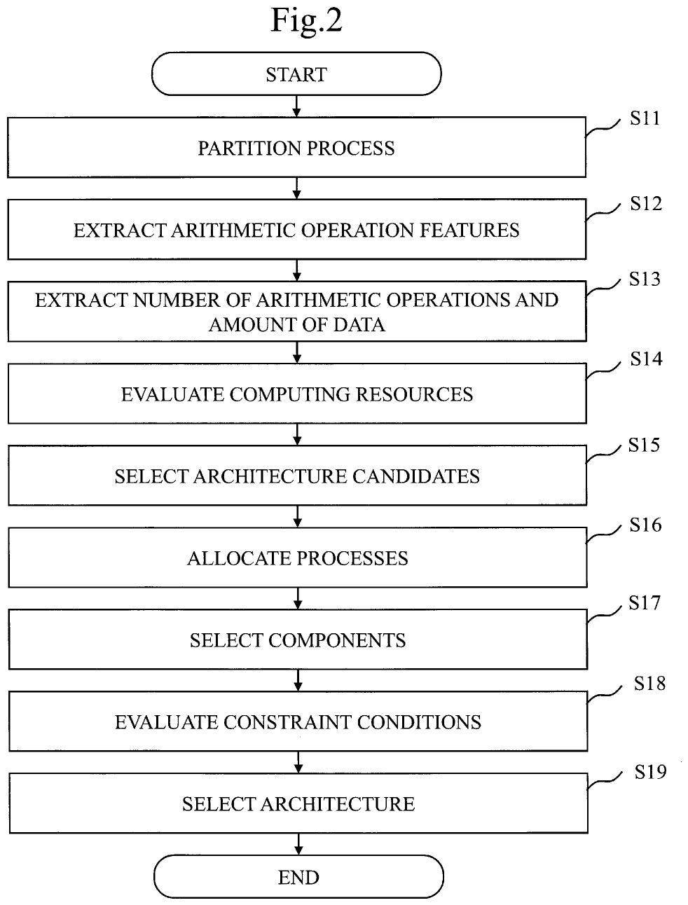

With reference to FIG. 2, operation of the architecture selection device 200 according to the embodiment will be described. The operation of the architecture selection device 200 corresponds to an architecture selection method according to the embodiment.

In step S11, the first analysis unit 201 receives the functional model 220 as input. The first analysis unit 201 conducts syntax analysis of the functional model 220. The first analysis unit 201 analyzes a program structure and data dependence and thereby partitions a process. Though any method may be used as a method of partitioning, the process is partitioned for each function call in the embodiment. The process is partitioned before and after a loop construct, as well.

As described above, the first analysis unit 201 that is one of the analysis units analyzes the functional model 220 that defines functions required for the system to be designed and thereby identifies a process to be executed by the system to be designed for fulfillment of the function. The first analysis unit 201 partitions the identified process into two or more processes. The two or more processes will be referred to as “processes after partition”, hereinbelow.

In step S12, the first analysis unit 201 extracts features such as types of arithmetic operations, loop processing, and input-output data that are used in each process after partition, through the syntax analysis of the functional model 220. The first analysis unit 201 outputs an extraction result as an analysis result on the functional model 220.

In step S13, the second analysis unit 202 performs a simulation by giving the test vector 221 to the functional model 220 and thereby measures a number of iteration of the loop processing, an amount of the input-output data, and the like that have been extracted as the analysis result outputted in step S12. The second analysis unit 202 outputs measurement results as measurement results of number of arithmetic operations and the amount of the data.

In step S14, the evaluation unit 203 evaluates processing power of each computing resource. The computing resource refers to candidates for processing components to be integrated into the system to be designed. The processing components refer to hardware components to execute the processes among the hardware components to be integrated into the system to be designed. Among the candidates for the processing components may be CPU, DSP, GPU, and FPGA. The term “DSP” is an abbreviation for Digital Signal Processor. The term “GPU” is an abbreviation for Graphics Processing Unit. The term “FPGA” is an abbreviation for Field-Programmable Gate Array. The computing resources are sorted by difference in CPU, DSP, GPU, and FPGA, difference in architecture of a processor core, and difference based on installation of floating-point unit or extended instruction unit.

Computing resource data to be criteria for evaluation of the processing power of each computing resource is stored in the computing resource database 210. The evaluation unit 203 calculates an evaluation value of each computing resource for each process after partition, based on the measurement results of the number of arithmetic operations and the amounts of the data that have been outputted in step S12 and step S13. The evaluation unit 203 outputs the calculated evaluation value as an evaluation result of the computing resource.

As described above, the evaluation unit 203 evaluates the performance of each candidate for the combination of the processing components to be integrated into the system to be designed.

In the embodiment, as will be described later, the evaluation unit 203 calculates an index value of time taken for execution of the process identified by the first analysis unit 201, as the evaluation value of the performance of each candidate of the combination of the processing components to be integrated into the system to be designed. As the index value of the time, MIPS is calculated in the embodiment, though any index value may be calculated and though a length of the time may be simply calculated. The term “MIPS” is an abbreviation for Million Instructions Per Second.

Though not essential, the first analysis unit 201 partitions the processes to be executed by the system to be designed, in the embodiment, as described above. Therefore, the evaluation unit 203 calculates the index value of the time taken for the execution of each process after partition for each candidate for the combination of the processing components to be integrated into the system to be designed. The evaluation unit 203 calculates total of the calculated index values of the time as the evaluation value of the performance.

In step S15, the first selection unit 204 selects architecture candidates from architecture information stored in the architecture database 211, based on the evaluation results on the computing resources outputted in step S14, the constraint definition 222, and the priority definition 223. In the constraint definition 222, constraint conditions on the performance and the costs are defined. A constraint condition on at least one type of cost is defined as the constraint conditions on the costs. Examples of types of the costs include expense that is initial cost, power consumption that is running cost, and area that is space cost. In the priority definition 223, priority levels of compliance with the constraint conditions on the performance and the costs and allowable ranges in easing of the conditions are defined.

Specifically, the first selection unit 204 analyzes a trend, a computation amount, and the like of process contents of the entire functional model 220, based on the evaluation values of the computing resources calculated in step S14. The first selection unit 204 analyzes a required level for the system based on the constraint definition 222 and the priority definition 223. Based on those analysis results, the first selection unit 204 searches the architecture database 211 for architecture of systems of past that has fulfilled process contents, a computation amount, and a required level that are equivalent. The first selection unit 204 outputs a search result as the architecture candidates.

Number of the architecture candidates to be selected may be limited to one or may be plural. In case where no architecture candidate satisfies the required level of the constraint definition 222, the first selection unit 204 selects architecture candidates with the required level of the constraint definition 222 relaxed in accordance with the priority definition 223.

In step S16, the aggregation unit 205 allocates the processes after partition to components that constitute the architecture candidates selected in step S15.

In step S17, the aggregation unit 205 builds architecture model candidates by retrieving, from the component information database 212, the components that constitute the architecture candidates selected in step S15. In the component information database 212, component information that defines costs of individual hardware components is stored. The component information is information that defines at least one type of cost among the expense that is the initial cost, the power consumption that is the running cost, and the area that is the space cost, as the costs of the individual hardware components.

In step S18, the aggregation unit 205 calculates evaluation values of the architecture model candidates that have been built.

As described above, the aggregation unit 205 acquires the component information from the memory 241. The aggregation unit 205 aggregates the costs of each candidate for the combination of the hardware components to be integrated into the system to be designed, based on the acquired component information.

In step S19, the second selection unit 206 narrows down the architectures to one architecture in accordance with the evaluation values calculated in step S18 and the constraint definition 222 and the priority definition 223. The second selection unit 206 outputs the architecture model 230 indicating the one architecture.

As described above, the first selection unit 204 and the second selection unit 206 that are the selection units select one combination of the hardware components, as the architecture of the system to be designed, from among the candidates for the combination of the hardware components to be integrated into the system to be designed. The combination of the hardware components that is to be selected is a combination of the hardware components which includes a combination of the processing components having the performance evaluated by the evaluation unit 203 satisfying the constraint conditions on the performance given to the system to be designed and whose costs aggregated by the aggregation unit 205 satisfy the constraint condition on the costs given to the system to be designed.

In the embodiment, the first selection unit 204 and the second selection unit 206 narrow down the candidates for the combination of the hardware components to be integrated into the system to be designed, by sequential application of the constraint conditions in descending order of priority level.

In the embodiment, as will be described later, the priority level of the constraint condition on the performance is set higher than the priority levels of the constraint conditions on the costs. Therefore, the first selection unit 204 first selects candidates for the combination of the hardware components including combinations of the processing components for which the index values of the time calculated by the evaluation unit 203 are equal to or lower than an upper limit determined as the constraint condition on the performance, from among the candidates for the combination of the hardware components to be integrated into the system to be designed. After that, the second selection unit 206 selects a combination of the hardware components whose costs aggregated by the aggregation unit 205 satisfy the constraint conditions on the costs, as the architecture of the system, from among the candidates for the combination of the hardware components selected by the first selection unit 204.

Hereinbelow, the operation of the architecture selection device 200 will be described with citation of examples of data that is treated by the architecture selection device 200.

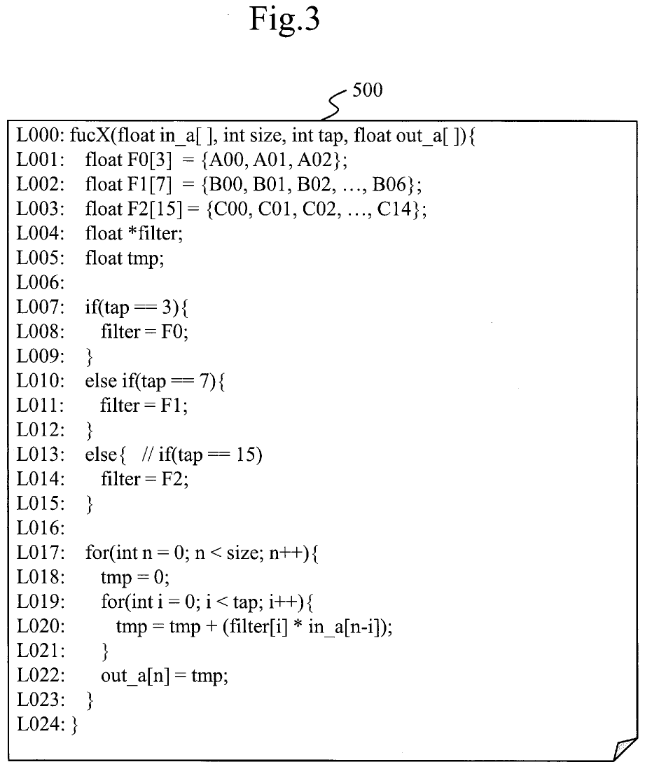

FIG. 3 illustrates a source code 500 in C language, as a description example of the functional model 220. A line number is described at a head of each line of the source code 500. The source code 500 is a portion of a source code of the entire functional model 220.

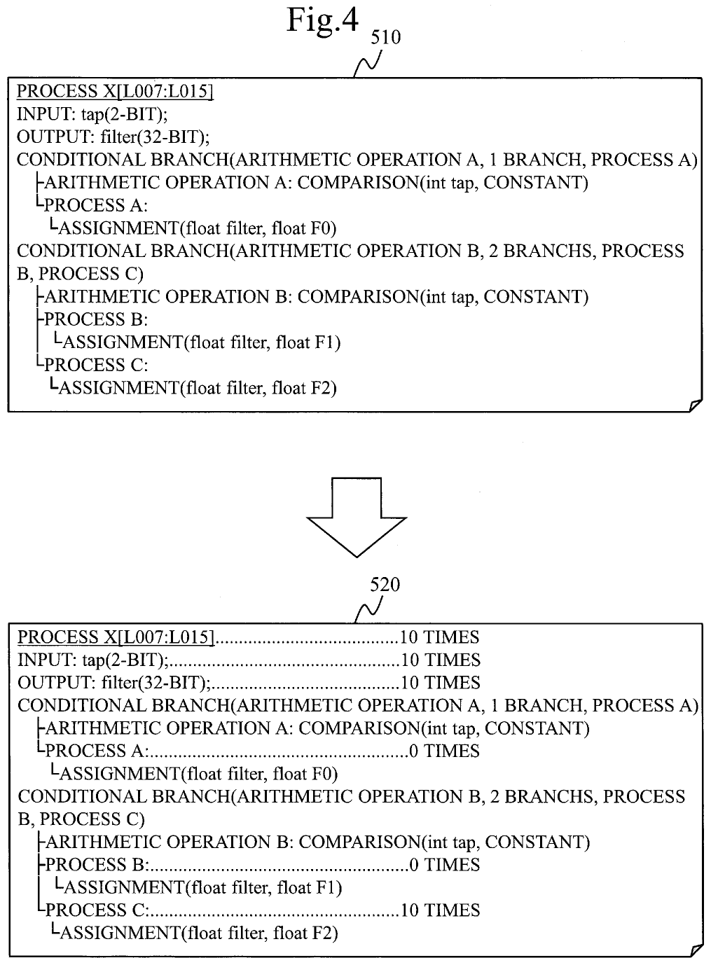

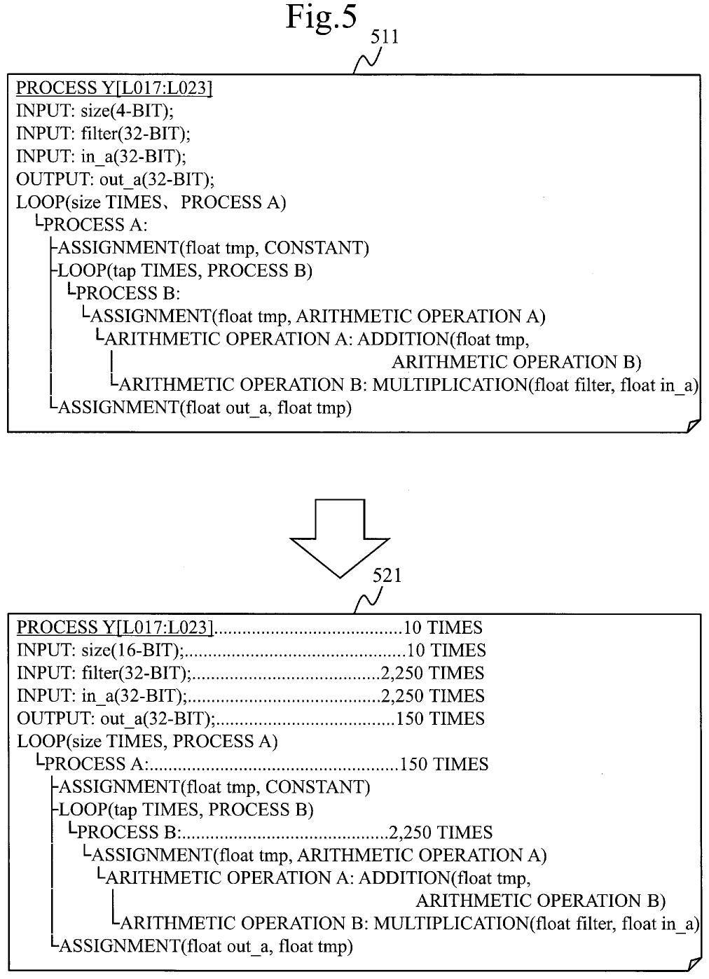

FIGS. 4 and 5 respectively illustrate an analysis result 510 on a process X and an analysis result 511 on a process Y, as examples of analysis results on the functional model 220 outputted by the first analysis unit 201.

When the first analysis unit 201 analyzes the source code 500 of the functional model 220 in step S11, the first analysis unit 201 extracts a portion from L007 to L015, which is sequentially processed from L007, as the one process X. The first analysis unit 201 extracts a portion from L017 to L023, which is iteratively processed based on a description of L017 belonging to loop processing, as the one process Y.

In step S12, the first analysis unit 201 analyzes the source code 500 of the functional model 220 and thereby extracts the types of the arithmetic operations, the loop processing, the input-output data, and the like that are used. The first analysis unit 201 builds analysis data on the process X by analyzing the portion from L007 to L015 of the source code 500 of the functional model 220. In addition, the first analysis unit 201 builds analysis data on the process Y by analyzing the portion from L017 to L023.

Specifically, the first analysis unit 201 extracts input and output variables in the entire process, a data width thereof, the process contents, and the types of the arithmetic operations and the input and output variables that are used, by the syntax analysis of the source code 500.

Furthermore, FIGS. 4 and 5 respectively illustrate a measurement result 520 of the process X and a measurement result 521 of the process Y, as examples of the measurement results of the number of the arithmetic operations and the amounts of the data that are outputted by the second analysis unit 202.

In step S13, the second analysis unit 202 measures number of the input-output data in the entire processes and number of executions of the processes for the analysis results 510 of the process X and the analysis result 511 of the process Y and adds measurement results.

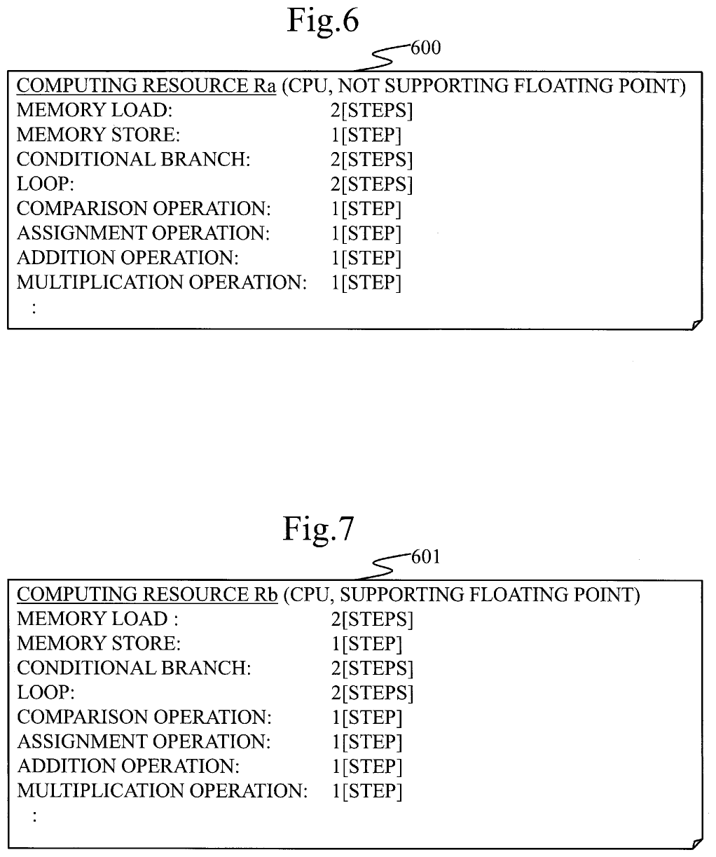

FIGS. 6, 7, 8, and 9 respectively illustrate computing resource data 600 on computing resource Ra, computing resource data 601 on computing resource Rb, computing resource data 602 on computing resource Rc, and computing resource data 603 on computing resource Rd, as examples of the computing resource data stored in the computing resource database 210. The computing resource data stores number of steps required for instructions for each computing resource, and the like.

The computing resource Ra is a CPU that does not support floating point. The computing resource Rb is a CPU that supports floating point. The computing resource Rc is a DSP that does not support floating point. The computing resource Rd is a DSP that supports floating point.

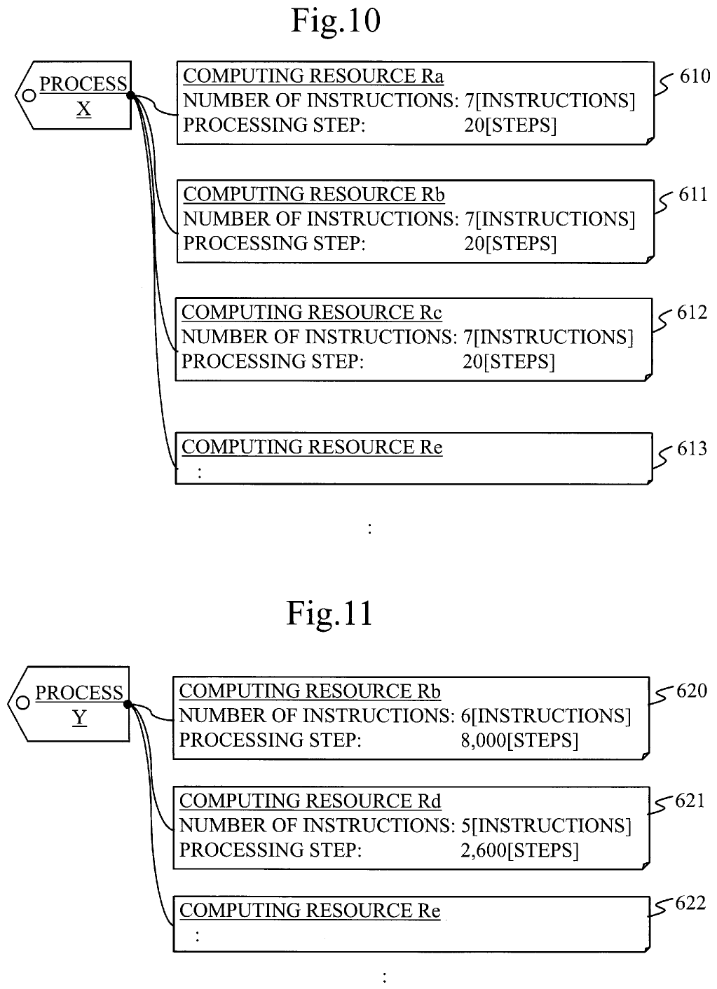

FIG. 10 illustrates data in which the evaluation values of the computing resources based on the computing resource data are added to the measurement result 520 of the process X of FIG. 4, as an example of intermediate data of step S14. As specific examples of such data, an evaluation result 610 of the computing resource Ra, an evaluation result 611 of the computing resource Rb, an evaluation result 612 of the computing resource Rc, and an evaluation result 613 of the computing resource Re are presented.

The evaluation result 610 of the computing resource Ra is a result of evaluation of performance of the computing resource Ra based on the computing resource data 600 on the computing resource Ra in relation to the measurement result 520 of the number of the arithmetic operations and the amounts of the data in the process X. The evaluation result 610 indicates that number of instructions required for the execution is 7 and that number of required processing steps is 20.

The evaluation result 611 of the computing resource Rb is a result of evaluation of performance of the computing resource Rb based on the computing resource data 601 on the computing resource Rb in relation to the measurement result 520 of the number of the arithmetic operations and the amounts of the data in the process X. The evaluation result 611 indicates that the number of the instructions required for the execution is 7 and that the number of the required processing steps is 20.

The evaluation result 612 of the computing resource Rc is a result of evaluation of performance of the computing resource Rc based on the computing resource data 602 on the computing resource Rc in relation to the measurement result 520 of the number of the arithmetic operations and the amounts of the data in the process X. The evaluation result 612 indicates that the number of the instructions required for the execution is 7 and that the number of the required processing steps is 20.

FIG. 11 illustrates data in which the evaluation values of the computing resources based on the computing resource data are added to the measurement result 521 of the process Y of FIG. 5, as an example of the intermediate data of step S14. As specific examples of such data, an evaluation result 620 of the computing resource Rb, an evaluation result 621 of the computing resource Rd, and an evaluation result 622 of the computing resource Re are presented.

The evaluation result 620 of the computing resource Rb is a result of evaluation of the performance of the computing resource Rb based on the computing resource data 601 on the computing resource Rb in relation to the measurement result 521 of the number of the arithmetic operations and the amounts of the data in the process Y. The evaluation result 620 indicates that the number of the instructions required for the execution is 6 and that the number of the required processing steps is 8,000.

The evaluation result 621 of the computing resource Rc is a result of evaluation of the performance of the computing resource Rc based on the computing resource data 602 on the computing resource Rc in relation to the measurement result 521 of the number of the arithmetic operations and the amounts of the data in the process Y. The evaluation result 621 indicates that the number of the instructions required for the execution is 5 and that the number of the required processing steps is 2,600.

In step S14, the evaluation unit 203 allocates processing steps for each arithmetic operation described in the computing resource data to the number of executions of the processes described in the measurement result of the number of the arithmetic operations and the amounts of the data and thereby calculates number of steps required for execution of each process after partition, for each computing resource. The evaluation unit 203 outputs the calculated number of steps as the evaluation results of the computing resources.

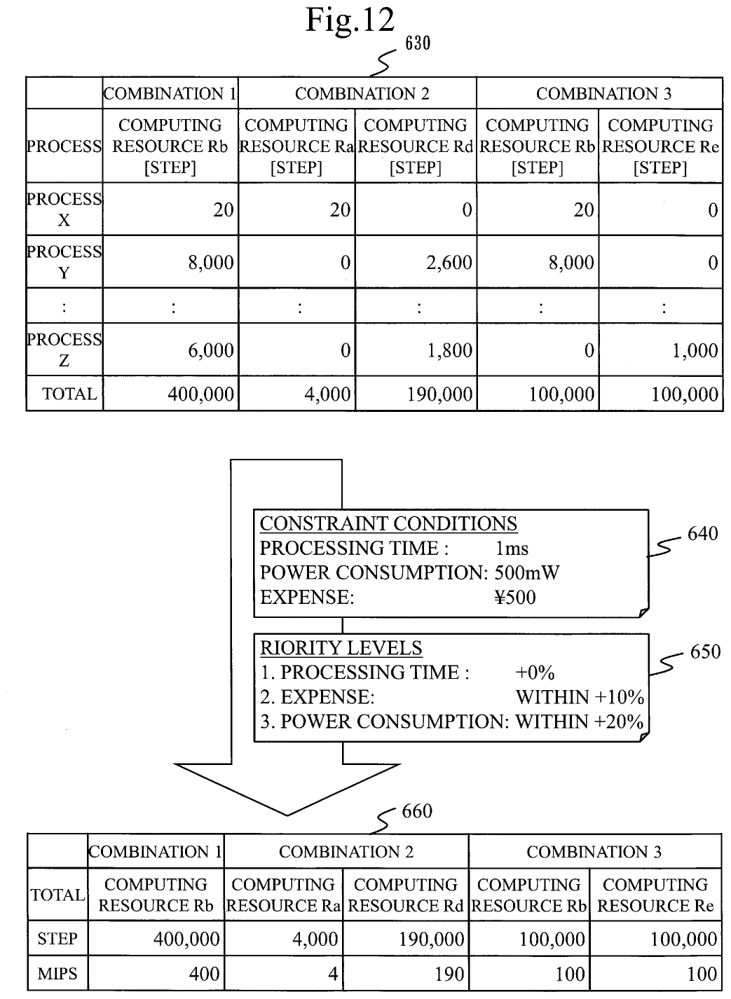

FIG. 12 illustrates an evaluation result 630 in which combinations of the computing resources required for construction of the system and the number of the steps required for the processes are calculated based on the evaluation values of the computing resources for each process of FIGS. 10 and 11, as an example of the evaluation results of the computing resources. The evaluation result 630 indicates that there are three methods of constructing the system, that is, combination 1, combination 2, and combination 3. The combination 1 may be constructed of merely the computing resource Rb and requires 400,000 steps. The combination 2 may be constructed of the computing resource Ra, which requires 4,000 steps, and the computing resource Rd, which requires 190,000 steps. The combination 3 may be constructed of the computing resource Rb, which requires 100,000 steps, and the computing resource Re, which requires 100,000 steps.

FIG. 12 further illustrates constraint conditions 640 and priority levels 650 as examples of the constraint definition 222 and the priority definition 223.

As the constraint conditions 640 on the performance, the upper limit of the processing time is defined. As the constraint conditions 640 on the power consumption, an upper limit of the power consumption is defined. As the constraint conditions 640 on the expense, an upper limit of the expense is defined.

Among the priority levels 650, the processing time is set the highest and the expense and the power consumption are subsequently placed in descending order. The allowable range of the processing time is “+0%” and it is therefore essential for the processing time to be 1 ms or shorter time. The allowable range of the expense is “within +10%” and it is therefore essential for the expense to be ¥550 or less. The allowable range of the power consumption is “within +20%” and it is therefore essential for the power consumption to be 600 mW or less.

A condition on the first priority level is a combination of the processing time=1 ms, the power consumption=500 mW, and the cost=¥500.

A condition on the second priority level is a combination of the processing time=1 ms, the power consumption=600 mW, and the cost=¥500.

A condition on the third priority level is a combination of the processing time=1 ms, the power consumption=600 mW, and the cost=¥550.

FIG. 12 further illustrates a result of calculation of the MIPS based on the constraint conditions 640 on the processing time in relation to the evaluation results 630 of the computing resources, as a calculation result 660. In the calculation result 660, it is indicated that 400 MIPS is required for the computing resource Rb of the combination 1. It is indicated that 4 MIPS is required for the computing resource Ra of the combination 2 and that 190 MIPS is required for the computing resource Rd of the combination 2. It is indicated that 100 MIPS is required for the computing resource Rb of the combination 3 and that 100 MIPS is required for the computing resource Re of the combination 3.

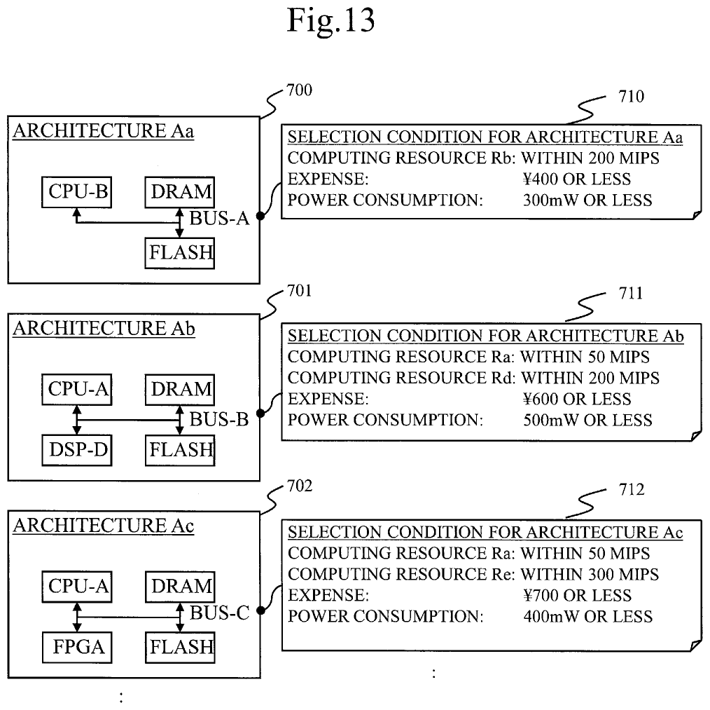

FIG. 13 illustrates an example of the architecture information stored in the architecture database 211. The architecture information is information that defines architecture and a selection condition therefor as a set.

Architecture information 700 for architecture Aa represents the architecture in which a CPU, a DRAM, and a FLASH are connected through a bus. The term “DRAM” is an abbreviation for Dynamic Random Access Memory. The term “FLASH” refers to a flash memory. As a selection condition 710 for the architecture Aa, a condition of the performance of the computing resource Rb within 200 MIPS, the expense of ¥400 or less, and the power consumption of 300 mW or less is defined.

Architecture information 701 for architecture Ab represents the architecture in which a CPU, a DSP, a DRAM, and a FLASH are connected through a bus. As a selection condition 711 for the architecture Ab, a condition of the performance of the computing resource Ra within 50 MIPS, the performance of the computing resource Rd within 200 MIPS, the expense of ¥600 or less, and the power consumption of 500 mW or less is defined.

Architecture information 702 for architecture Ac represents the architecture in which a CPU, an FPGA, a DRAM, and a FLASH are connected through a bus. As a selection condition 712 for the architecture Ac, a condition of the performance of the computing resource Ra within 50 MIPS, the performance of the computing resource Re within 200 MIPS, the expense of ¥700 or less, and the power consumption of 400 mW or less is defined.

In step S15, the first selection unit 204 makes a comparison in the architecture information of FIG. 13 in accordance with the MIPS required for each computing resource that is described in the calculation result 660 of FIG. 12 and the constraint conditions 640 on the power consumption and the expense of FIG. 12. The first selection unit 204 selects the architecture Ab and the architecture Ac as the architecture candidates because the architecture Ab and the architecture Ac satisfy the conditions.

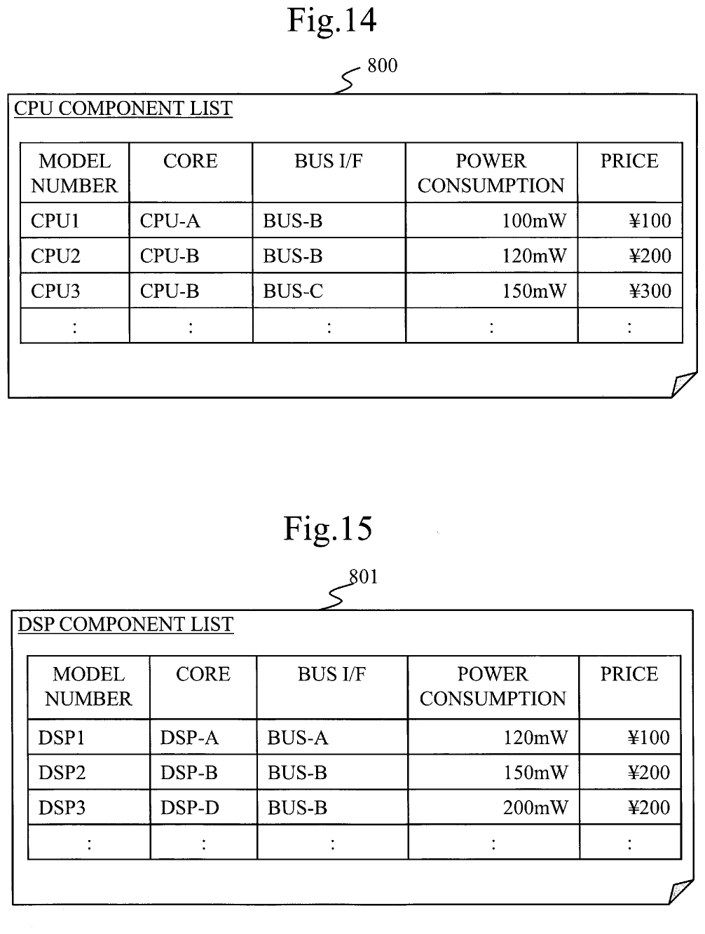

FIGS. 14 and 15 respectively illustrate component information 800 on CPUs and component information 801 on DSPs, as examples of the component information stored in the component information database 212.

The component information 800 on CPUs includes information on model number, type of core, bus interface, power consumption, and price of each CPU component.

The component information 801 on DSPs includes information on model number, type of core, bus interface, power consumption, and price of each DSP component.

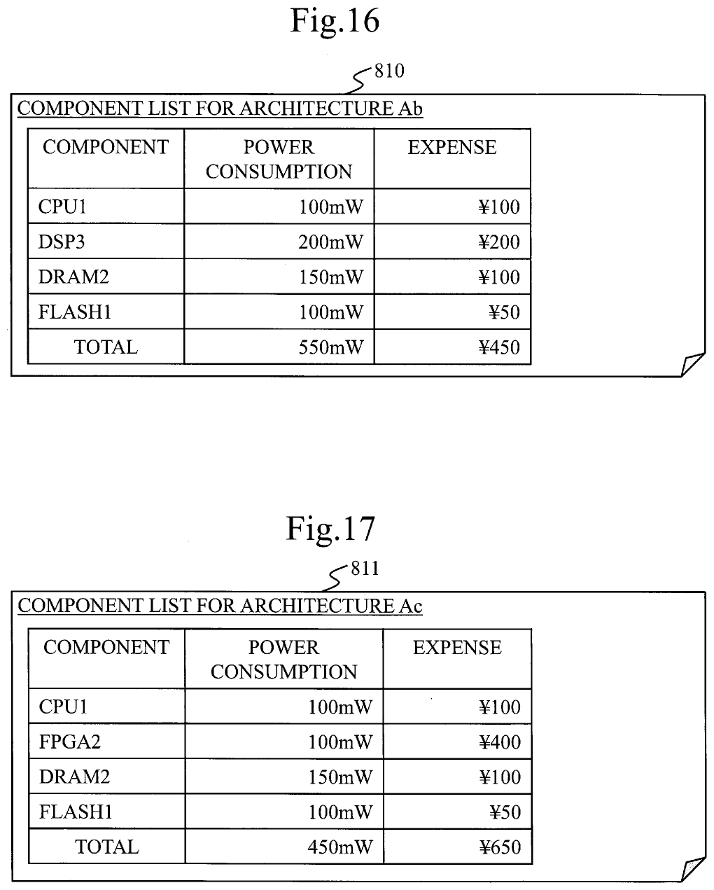

FIGS. 16 and 17 respectively illustrate a selection result 810 for components of the architecture Ab and a selection result 811 for components of the architecture Ac, as examples of the architecture model candidates of step S17.

In step S17, the aggregation unit 205 extracts information on the components, that is, CPU, DSP, DRAM, and FLASH, which constitute the architecture Ab, from the component information 800 on CPUs, the component information 801 on DSPs, and the like. In step S18, the aggregation unit 205 calculates the power consumption and the expense from the extracted information. The aggregation unit 205 outputs a calculation result as the selection result 810.

In step S17, the aggregation unit 205 extracts information on the components, that is, CPU, FPGA, DRAM, and FLASH, which constitute the architecture Ac, from the component information 800 on CPUs and the like. In step S18, the aggregation unit 205 calculates the power consumption and the expense from the extracted information. The aggregation unit 205 outputs a calculation result as the selection result 811.

In the selection result 810 for the architecture Ab, the power consumption is 550 mW and the expense is ¥450. In the selection result 811 for the architecture Ac, the power consumption is 450 mW and the expense is ¥650.

In step S19, the second selection unit 206 determines whether the selection result 810 for the architecture Ab and the selection result 811 for the architecture Ac satisfy the constraints in the constraint conditions 640 on the power consumption and the expense and the priority levels 650 of FIG. 12 or not.

As described above, the condition on the first priority level is the combination of the processing time=1 ms, the power consumption=500 mW, and the cost=¥500. In the selection result 810 for the architecture Ab, in relation to the condition, the expense satisfies the constraint condition, while the power consumption does not satisfy constraint condition. In the selection result 811 for the architecture Ac, the power consumption satisfies the constraint condition, while the expense does not satisfy the constraint condition.

As described above, the condition on the second priority level is the combination of the processing time=1 ms, the power consumption=600 mW, and the cost=¥500. In the selection result 810 for the architecture Ab, in relation to the condition, both the expense and the power consumption satisfy the constraint condition. In the selection result 811 for the architecture Ac; the power consumption satisfies the constraint condition, while the expense does not satisfy the constraint condition.

In step S19, based on the above evaluation results on the constraint conditions, the architecture Ab that satisfies the condition on the second priority level is conclusively selected.

***Description on Effects of Embodiment***

According to the embodiment, it is made possible to select the combination of components that satisfies the constraint conditions on the performance and the costs, as the architecture of a system, without depending on the system designer.

***Other Configurations***

Though the functions of the first analysis unit 201, the second analysis unit 202, the evaluation unit 203, the first selection unit 204, the aggregation unit 205, and the second selection unit 206 are implemented by the software in the embodiment, the functions of the first analysis unit 201, the second analysis unit 202, the evaluation unit 203, the first selection unit 204, the aggregation unit 205, and the second selection unit 206 may be implemented by a combination of software and hardware in a modification. That is, a portion of the functions of the first analysis unit 201, the second analysis unit 202, the evaluation unit 203, the first selection unit 204, the aggregation unit 205, and the second selection unit 206 may be implemented by dedicated electronic circuits and the remainder may be implemented by software.

The dedicated electronic circuits are single circuits, composite circuits, programmed processors, parallelly programmed processors, logic ICs, GAs, FPGAs, or ASICs, for instance. The term “GA” is an abbreviation for Gate Array. The term “ASIC” is an abbreviation for Application Specific Integrated Circuit.

The processor 240, the memory 241, and the dedicated electronic circuits are collectively referred to as “processing circuitry”. That is, the functions of the first analysis unit 201, the second analysis unit 202, the evaluation unit 203, the first selection unit 204, the aggregation unit 205, and the second selection unit 206 are implemented by the processing circuitry, irrespective of whether the functions of the first analysis unit 201, the second analysis unit 202, the evaluation unit 203, the first selection unit 204, the aggregation unit 205, and the second selection unit 206 are implemented by software or are implemented by a combination of software and hardware.

The “device” of the architecture selection device 200 may be read as “method” and the “unit” of the first analysis unit 201, the second analysis unit 202, the evaluation unit 203, the first selection unit 204, the aggregation unit 205, and the second selection unit 206 may be read as “step”. Alternatively, the “device” of the architecture selection device 200 may be read as “program”, “program product”, or “computer-readable medium having a program recorded therein” and the “unit” of the first analysis unit 201, the second analysis unit 202, the evaluation unit 203, the first selection unit 204, the aggregation unit 205, and the second selection unit 206 may be read as “procedure” or “process”.

### REFERENCE SIGNS LIST

100: design support system; 200: architecture selection device; 201: first analysis unit; 202: second analysis unit; 203: evaluation unit; 204: first selection unit; 205: aggregation unit; 206: second selection unit; 210: computing resource database; 211: architecture database; 212: component information database; 220: functional model; 221: test vector; 222: constraint definition; 223: priority definition; 230: architecture model; 240: processor; 241: memory; 242: input interface; 243: display interface; 300: HW/SW partition device; 400: HW/SW design device; 500: source code; 510: analysis result; 511: analysis result; 520: measurement result; 521: measurement result; 600: computing resource data; 601: computing resource data; 602: computing resource data; 603: computing resource data; 610: evaluation result; 611: evaluation result; 612: evaluation result; 613: evaluation result; 620: evaluation result; 621: evaluation result; 622: evaluation result; 630: evaluation result; 640: constraint conditions; 650: priority levels; 660: calculation result; 700: architecture information; 701: architecture information; 702: architecture information; 710: selection condition; 711: selection condition; 712: selection condition; 800: component information; 801: component information; 810: selection result; 811: selection result

1.-8. (canceled)

9. An architecture selection device comprising:
processing circuitry
to evaluate performance of each of candidates for a combination of processing components that are hardware components to execute processes among hardware components to be integrated into a system to be designed;
to acquire component information defining costs of the individual hardware components from a memory and to aggregate costs of each of candidates for a combination of the hardware components to be integrated into the system, based on the acquired component information; and
to select a candidate for the combination of the hardware components which includes a combination of the processing components having the performance evaluated satisfying a constraint condition on the performance given to the system and whose costs aggregated satisfy a constraint condition on the costs given to the system, as architecture of the system, from among the candidates for the combination of the hardware components to be integrated into the system.

10. The architecture selection device according to claim 9, wherein
the component information is information that defines at least one type of cost among expense that is an initial cost, power consumption that is a running cost, and area that is a space cost, as the costs of the individual hardware components.

11. The architecture selection device according to claim 9, wherein
the processing circuitry narrows down the candidates for the combination of the hardware components to be integrated into the system, by sequential application of constraint conditions in descending order of priority level.

12. The architecture selection device according to claim 11, wherein
the priority level of the constraint condition on the performance is set higher than the priority level of the constraint condition on the costs.

13. The architecture selection device according to claim 12,
the processing circuitry analyzes a functional model that defines functions required for the system and to identify a process to be executed by the system for fulfillment of the functions,
the processing circuitry calculates an index value of time taken for execution of the process identified, as an evaluation value of the performance for each of the candidates of the combination of the processing components to be integrated into the system, and
the processing circuitry selects candidates for the combination of the hardware components including a combination of processing components having the index value of the time calculated being equal to or lower than an upper limit determined as the constraint condition on the performance given to the system, from among the candidates for the combination of the hardware components to be integrated into the system, and selects a combination of hardware components whose costs aggregated satisfy the constraint condition on the costs given to the system, as the architecture of the system, from among the selected candidates for the combination of the hardware components.

14. The architecture selection device according to claim 13, wherein
the processing circuitry partitions the identified process into two or more processes, and
the processing circuitry calculates an index value of time taken for execution of each of the two or more processes for each of the candidates of the combination of the processing components to be integrated into the system and calculates total of the calculated index values of the time as the evaluation value of the performance.

15. The architecture selection device according to claim 10, wherein
the processing circuitry narrows down the candidates for the combination of the hardware components to be integrated into the system, by sequential application of constraint conditions in descending order of priority level.

16. The architecture selection device according to claim 15, wherein
the priority level of the constraint condition on the performance is set higher than the priority level of the constraint condition on the costs.

17. The architecture selection device according to claim 16,
the processing circuitry analyzes a functional model that defines functions required for the system and to identify a process to be executed by the system for fulfillment of the functions,
the processing circuitry calculates an index value of time taken for execution of the process identified, as an evaluation value of the performance for each of the candidates of the combination of the processing components to be integrated into the system, and
the processing circuitry selects candidates for the combination of the hardware components including a combination of processing components having the index value of the time calculated being equal to or lower than an upper limit determined as the constraint condition on the performance given to the system, from among the candidates for the combination of the hardware components to be integrated into the system, and selects a combination of hardware components whose costs aggregated satisfy the constraint condition on the costs given to the system, as the architecture of the system, from among the selected candidates for the combination of the hardware components.

18. The architecture selection device according to claim 17, wherein
the processing circuitry partitions the identified process into two or more processes, and
the processing circuitry calculates an index value of time taken for execution of each of the two or more processes for each of the candidates of the combination of the processing components to be integrated into the system and calculates total of the calculated index values of the time as the evaluation value of the performance.

19. An architecture selection method comprising:
evaluating, by an evaluation unit, performance of each of candidates for a combination of processing components that are hardware components to execute processes among hardware components to be integrated into a system to be designed;
acquiring, by an aggregation unit, component information defining costs of the individual hardware components from a memory and aggregating costs of each of candidates for a combination of the hardware components to be integrated into the system, based on the acquired component information; and
selecting, by a selection unit, a candidate for the combination of the hardware components which includes a combination of the processing components having the performance evaluated by the evaluation unit satisfying a constraint condition on the performance given to the system and whose costs aggregated by the aggregation unit satisfy a constraint condition on the costs given to the system, as architecture of the system, from among the candidates for the combination of the hardware components to be integrated into the system.

20. A computer readable medium having an architecture selection program that causes a computer to execute:
an evaluation procedure of evaluating performance of each of candidates for a combination of processing components that are hardware components to execute processes among hardware components to be integrated into a system to be designed;
an aggregation procedure of acquiring component information defining costs of the individual hardware components from a memory and aggregating costs of each of candidates for a combination of the hardware components to be integrated into the system, based on the acquired component information; and
a selection procedure of selecting a candidate for the combination of the hardware components which includes a combination of the processing components having the performance evaluated in the evaluation procedure satisfying a constraint condition on the performance given to the system and whose costs aggregated in the aggregation procedure satisfy a constraint condition on the costs given to the system, as architecture of the system, from among the candidates for the combination of the hardware components to be integrated into the system.
